(19) United States
(12) Patent Application Publication
(10) Pub. No.: US 2018/0202201 A1
(43) Pub. Date: Jul. 19, 2018

(54) Apparatus and Method for Securing Railcar Doors

(71) Applicant: Trinity North American Freight Car, Inc., Dallas, TX (US)

(72) Inventor: Robert J. Cencer, Tipton, MI (US)

(21) Appl. No.: 15/407,732

(22) Filed: Jan. 17, 2017

(51) Int. Cl. E05B 83/02; E05B 35/00; B61D 19/00

(52) U.S. Cl. CPC E05B 83/02; B61D 19/001; E05B 35/008

(57) ABSTRACT

According to some embodiments, an apparatus for railcar doors comprises a locking plug configured to be disposed within a square key hole. The locking plug comprises a front portion defining a recess having a recess shape. The apparatus comprises a key element. The key element comprises a key element shaft having a shape corresponding to the recess shape. The key element is configured to be inserted into the locking plug and to transfer a torsional force from the key element to the square key hole. In particular embodiments, the locking plug may comprise a back portion. The locking plug is disposed within the square key hole by a weld connecting the back portion of the locking plug to a portion of the square key hole.

### TECHNICAL FIELD

This disclosure generally relates to railcars, and more particularly to securing square key holes on railcar doors, such as end doors on auto racks, for example.

### BACKGROUND

Railcars are integral to the transportation of goods across the country. Railcars come in many configurations depending on their intended cargo. For example, railcars can be configured to carry automobiles. Such railcars, also known as auto racks, may be the target of thefts. Certain locking mechanisms have been developed to protect railcars from unauthorized entry. The main measure used is a latch between the doors on the railcar, which is secured by a bolt seal or another lock. The latch and bolt seal combination can serve as a deterrent by requiring the removal of the bolt seal before the doors can be opened. Bolt seals and other locks often fail, however, to serve their deterrent effect because thieves can easily remove them with commonly acquired tools. Instead, locks on the latch between doors merely indicate whether the cargo has been tampered with and the receiver of the railcar should report an unauthorized access.

In order to protect cargo, such as automobiles in auto racks, additional security measures have been proposed. These include additional latches and bolt seals that prevent the doors or other access points to the interior of the railcar from opening. Additional bolt seals could increase the amount of time in which the thieves must expose themselves to detection while attempting to access the cargo. Yet, little additional effort is required to break additional seals or locks. Thus, the cost and time to add additional seals or locks often outweighs the increase in security of the railcars. Once any seals or fasteners are removed, the thief need only engage the square key hole before opening the doors and accessing the cargo within the railcar.

### SUMMARY

Particular embodiments described herein include an apparatus for securing railcar doors, such as end doors on auto racks. According to some embodiments, an apparatus for railcar doors comprises a locking plug configured to be disposed within a square key hole. The locking plug comprises a front portion defining a recess having a recess shape. The apparatus comprises a key element. The key element comprises a key element shaft having a shape corresponding to the recess shape. The key element is configured to be inserted into the locking plug and to transfer a torsional force from the key element to the square key hole.

In particular embodiments, the locking plug may further comprise a back portion. The locking plug is disposed within the square key hole by a weld connecting the back portion of the locking plug to a portion of the square key hole.

In particular embodiments, the key element may further comprise a hexagonal head portion.

In particular embodiments, the locking plug further comprises an island shaft within the recess. The key element shaft defines a corresponding island recess.

In particular embodiments, the recess having a recess shape may have a polygonal shape. In some embodiments, the recess shape may be square. In other embodiments, the recess shape may be hexagonal.

In particular embodiments, the apparatus may be coupled to a locking mechanism of at least one railcar door. The locking mechanism is configured to be activated when the key element is inserted into the locking plug and torsional force is applied by the key element.

In another embodiment, the disclosure includes a method for securing railcar doors that comprises inserting a locking plug into a square key hole. The locking plug comprises a front portion defining a recess having a recess shape. A key element comprises a key element shaft having a shape corresponding to the recess shape. The key element is configured to be inserted into the locking plug and to transfer a torsional force from the key element to the square key hole.

In particular embodiments, the locking plug may further comprise a back portion. Inserting the locking plug into the square key hole includes welding the back portion of the locking plug to a portion of the square key hole.

In particular embodiments, the key element may further comprise a hexagonal head portion.

In particular embodiments, the locking plug may further comprise an island shaft within the recess. The key element shaft defines a corresponding island recess.

In particular embodiments, the recess having a recess shape may have a polygonal shape. In some embodiments, the recess shape may be square. In other embodiments, the recess shape may be hexagonal.

In particular embodiments, the method of inserting the locking plug may further include coupling the locking plug to a locking mechanism of at least one railcar door. The locking mechanism is configured to be activated when the key element is inserted into the locking plug and torsional force is applied by the key element.

In another embodiment, the disclosure includes an apparatus comprising at least one railcar door. The at least one railcar door comprises a locking mechanism. The locking mechanism defines a square key hole. The locking mechanism is connected to at least one locking pin. The apparatus comprises a locking plug configured to be disposed within the square key hole. The locking plug comprises a front portion defining a recess having a recess shape. The apparatus further comprises a key element comprising a key element shaft having a shape corresponding to the recess shape. The key element is configured to be inserted into the locking plug and to transfer a torsional force from the key element to the square key hole. The torsional force from the key element operates to turn the square key hole activating the at least one locking pin to allow the at least one rail car door to be opened.

In particular embodiments, the locking plug may further comprise a back portion. The locking plug is disposed within the square key hole by a weld connecting the back portion of the locking plug to a portion of the square key hole.

In particular embodiments, the key element may further comprise a hexagonal head portion.

In particular embodiments, the locking plug may further comprise an island shaft within the recess. The key element shaft defines a corresponding island recess.

In particular embodiments, the recess having a recess shape may have polygonal shape. In some embodiments, the recess shape may be square. In other embodiments, the recess shape may be hexagonal.

As a result, particular embodiments of the present disclosure may provide numerous technical advantages. For example, particular embodiments may provide additional security by preventing access to railcars beyond the addition of more bolt seals or other locks, such as pad locks. Newly constructed railcars may include square key locking plugs or existing railcars with square key holes may be retrofitted with locking plugs to prevent unauthorized access to the railcars. The locking plugs may prevent the engagement of the square key hole without the corresponding key element the railcar doors from being opened.

In particular embodiments, the locking plugs may be inserted into an existing square key hole and secured by a weld. The weld would prevent easy removal of the locking plugs, but would also allow for periodic replacement of the locking plug. The key elements corresponding to particular locking plugs may be serialized, allowing lost or stolen keys to be traced to particular operators or vendors, providing an additional layer of deterrence.

Additionally, a variety of recess shapes may be produced, increasing the difficulty of acquiring the corresponding key element in order to gain unauthorized access to the railcar. The locking plug may define a recess with a regular polygonal shape, such as a square or a hexagon.

The key element may include a head portion with a commonly used shape for transmitting torsional force, providing compatibility with commonly used tools. The locking plug and key element combination may include an island shaft and island recess pair which work together to ensure a better fit between the locking plug and key element in operation and make counterfeiting more difficult.

Particular embodiments of the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1 is a schematic drawing of an example railcar in perspective view, according to some embodiments;

FIG. 2A is a schematic drawing in front elevation showing an end view of an example railcar and its doors, according to some embodiments;

FIG. 2B is a schematic drawing of FIG. 2A in a particular mode of operation, according to some embodiments;

FIG. 3A is a schematic drawing in front elevation of an example square key hole of a railcar end door, according to some embodiments;

FIG. 3B is an cross-section side view of the square key hole of FIG. 3A, according to a some embodiments;

FIG. 4 is a schematic drawing in perspective view of an example square key, according to a particular embodiment;

FIG. 5 is a schematic drawing in perspective view of a square key hole locking plug, according to a particular embodiment;

FIG. 6 is a schematic drawing in front elevation of an example locking plug disposed within an example square key hole, according to a particular embodiment;

FIG. 7 is a schematic drawing in perspective view of example key element, according to a particular embodiment;

FIG. 8A is a schematic drawing in sectional elevation of an example key element inserted within an example locking plug disposed within an example square key hole, according to a particular embodiment;

FIG. 8B is a cross-section side view of FIG. 8A;

FIGS. 9A-C are schematic drawings in perspective view of example locking plugs, according to various particular embodiments; and

FIG. 10 is a flow diagram illustrating an example method of securing rail car doors, according to some embodiments.

### DETAILED DESCRIPTION

Particular embodiments include an apparatus for securing railcar doors, including end doors on auto racks. The safety and integrity of cargo shipped in railcars is important for both shipping and receiving parties to ensure goods make it to their destination on time and in good condition. Unauthorized access to cargo on railcars disrupts the normal course of business, requiring time consuming investigations and the replacement of missing or damaged goods.

While railcar access points, for example railcar doors, are often secured with a latch or similar clasp with a bolt seal or an other lock, such means are an insufficient deterrent to prevent unauthorized access to cargo on railcars. Bolt seals are easily removed and locks, such as padlocks are easily bypassed. In practice, the bolt seals and padlocks merely indicate tampering after the fact.

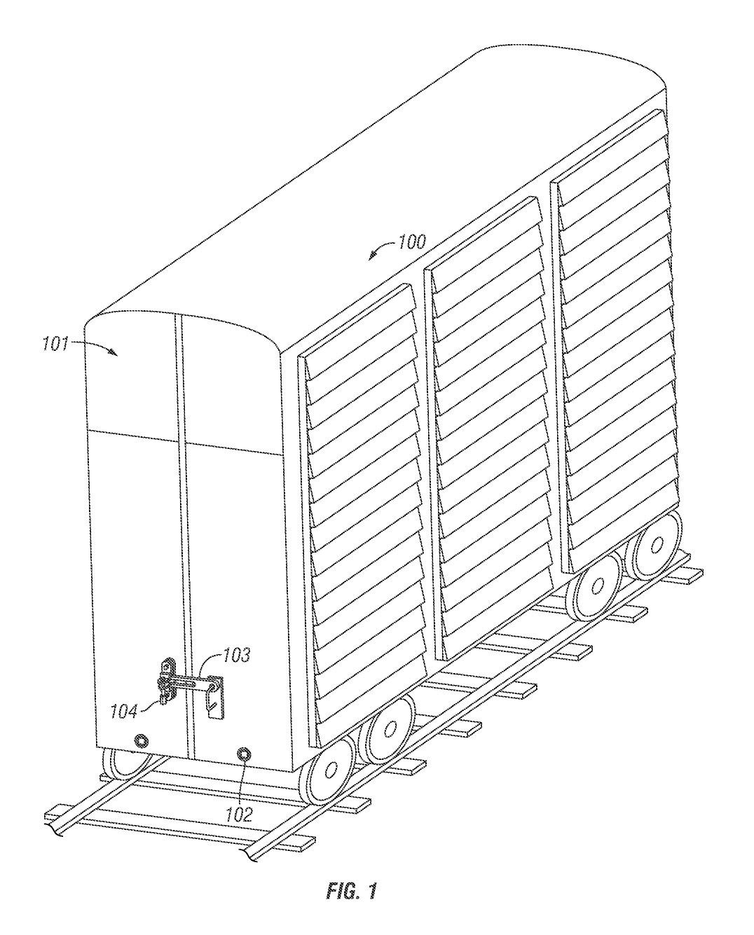

Particular embodiments increase the security of railcar doors while avoiding the problems described above and include an apparatus for securing railcar doors. The apparatus comprises a locking plug configured to be disposed within a square key hole, the locking plug comprising a front portion defining a recess having a recess shape and a key element comprising a key element shaft having a shape corresponding to the recess shape, the key element configured to be inserted into the locking plug and to transfer a torsional force from the key element to the square key hole. Particular embodiments of the invention and its advantages are best understood by reference to FIGS. 1 through 10, wherein like reference numbers indicate like features.

FIG. 1 is a schematic drawing of an example railcar in perspective view, according to some embodiments. Railcar 100 may carry cargo or other goods, such as automobiles. Railcar 100 comprises at least one cargo access point, for example, the doors 101 on the railcar 100. The doors 101 may open by swinging on a hinge or sliding along a track. An operator must first engage a square key hole 102 to allow the doors 101 to be opened. As illustrated, the railcar 100 has two end doors 101. Although a particular type of railcar is illustrated, other embodiments may include any type of railcar with at least one square key hole. Particular embodiments may include railcars with only one access point, for example a single railcar door. Other embodiments may include railcars with more than two access points requiring the engagement of at least one square key hole.

As illustrated, each of the doors 101 has a separate square key hole 102 that may be engaged to allow the doors 101 to be opened. In particular embodiments, there may only be one square key hole 102 for multiple access points which may be opened to provide access into the railcar. In such embodiments, engaging the square key hole 102 may allow the opening of the multiple access points.

The railcar 100 may also include a security mechanism to prevent access to the interior of the railcar by securing the railcar doors 101 together. The railcar 100 may include a latch 103 between the doors 101 that is fastened by a bolt seal 104. The latch 103 fastened by a bolt seal 104 prevents the doors 101 from opening even if the square key hole 102 is engaged. In some embodiments, the latch 103 is secured by another fastener, for example a padlock.

In particular embodiments, the railcar has only one door or access point. In such embodiments, the latch 103 may be mounted between the one door or access point and another part of the railcar 100 to prevent the one end door from opening when fastened with a seal. In other embodiments, there may be a plurality of latches or similar restraints and respective fasteners which prevent the opening of access points into the interior of the railcar 100 even if the square key hole 102 is engaged.

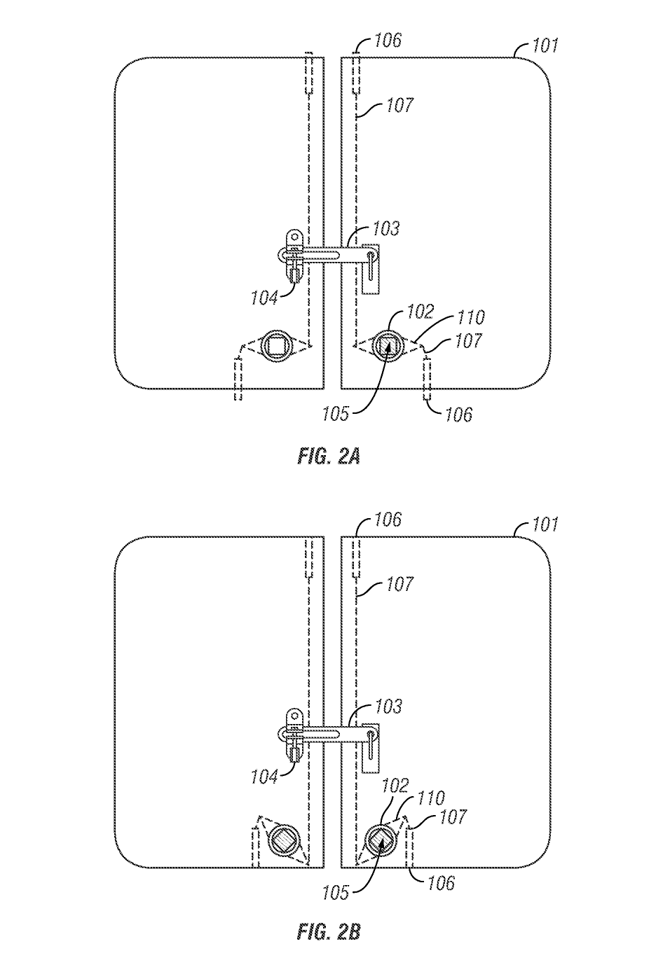

FIG. 2A is a schematic drawing in front elevation showing an end view of an example railcar and its doors, according to some embodiments. The doors 101 may comprise a square key hole 102 connected to a turning member 110. The turning member 110 is operable to turn when the square key hole 102 is engaged. The end doors 101 may further include locking pins 106 connected to the turning member 110 by connectors 107. The locking pins 106 operate to secure the doors 101 in place in at least a closed position. In the illustrated embodiment the square key hole 102 is coupled to two locking pins 106 at the top and bottom of one of the doors 101. In particular embodiments, there may only be one locking pin 106. In other embodiments, there may be more than two locking pins 106. In particular embodiments, a single square key hole 102 may be engaged to unlock more than one door of a railcar 100.

FIG. 2B is a schematic drawing of FIG. 2A in a particular mode of operation, according to some embodiments. The square key hole 102 may be engaged, causing the rotation of the square key hole 102, and thereby, rotating the turning member 110. When the square key hole 102 is engaged, the turning member 110 rotates and operates to move the connectors 107 such that the locking pins 106 are disengaged, allowing the end doors 101 to be opened. In particular embodiments, the square key hole 102 is coupled to the locking pins 106 directly. In other embodiments, the locking pins 106 are engaged by a different mechanism coupled to the rotation of the square key hole 102.

The illustrated embodiment of the locking mechanism coupled to the square key hole 102 is merely one example of a locking mechanism used in railcar doors. Any suitable railcar door locking mechanism that may be coupled to a square key hole would be appreciated by one of ordinary skill in the art upon viewing this disclosure.

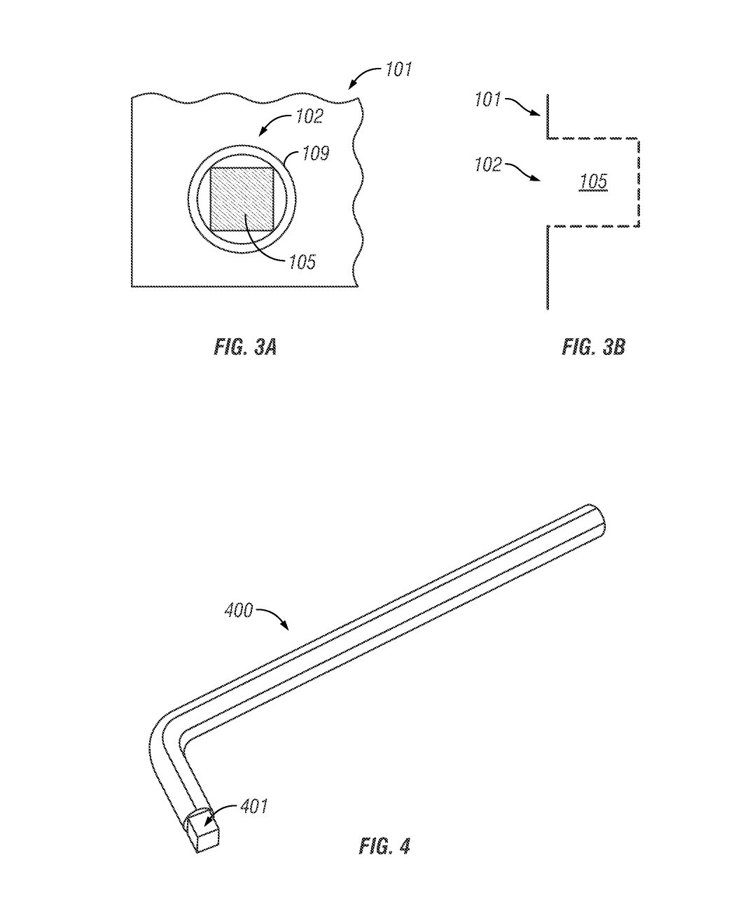

FIG. 3A is a schematic drawing in front elevation of an example square key hole of a rail car end door, according to some embodiments. The square key hole 102 is disposed within the doors 101. The square key hole 102 defines a square recess 105 in which an object may be inserted in order to engage the square key hole 102. The square recess 105 may have a substantially square cross-section. The square recess 105 may be defined to have various depths within the square key hole 102, such that in some embodiments, the square recess 105 is defined to be a cube or a rectangular prism.

In some embodiments, the square key hole includes a lip 109. The lip 109 may prevent debris or other objects from entering the square recess 105 inadvertently. One having ordinary skill in the art, in viewing this disclosure, would appreciate that in particular embodiments, the square key hole 102 may comprise other coverings or flaps to prevent the entry of debris into the square recess 105.

FIG. 3B is a cross-section side view of the square key hole of FIG. 3A, according to some embodiments. FIG. 3B depicts a side-on view of the square recess 105 formed within the square key hole 102 within the end doors 101. In particular embodiments, the entire square recess 105 is disposed within the doors 101. In other embodiments, only a portion of the square recess 105 is disposed within the interior of the doors 101. In particular embodiments, the square recess 105 may be defined by the square key hole 102 which extends a distance away from the doors 101.

FIG. 4 is a schematic drawing in perspective view of an example square key, according to a particular embodiment. The square key 400 includes a square head 401 and a handle 402. The square head 401 is proportioned to be inserted into the square recess 105. The square key 400 operates to engage the square key hole 102. The square head 401 is inserted into the square recess 105 such that it when the square key 400 is turned, the square head 401 transfers a torsional force to the square key hole 102, thereby engaging the square key hole 102. The handle 402 may be an elongated member allowing for a linear force to be translated into a torsional force in order to engage the square key hole 102. In particular embodiments, the square key may be a square bit attached to a driving mechanism providing a torsional force to the square bit. In other embodiments, the square key handle 402 may take a form in order to allow for better grip within a human hand operating the square key 400 to engage the square key hole 102.

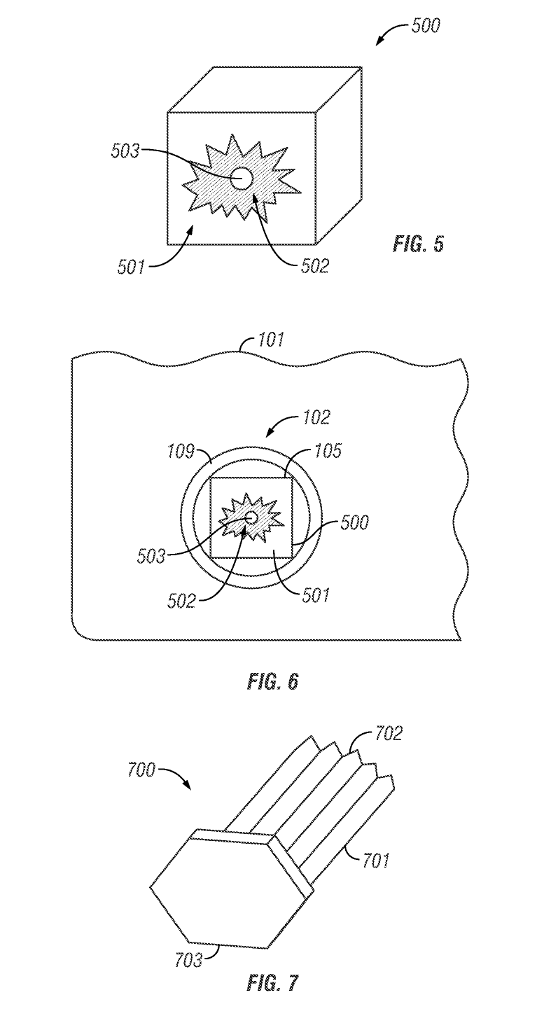

FIG. 5 is a schematic drawing in perspective view of a square key hole locking plug, according to a particular embodiment. The locking plug 500 may be configured to be disposed within a square key hole 102. The locking plug 500 may have a front portion 501. The front portion may define a recess 502 having a recess shape. In particular embodiments, the locking plug 500 has an island shaft 503, within the recess 502, extending towards the front portion 501. In particular embodiments, the locking plug 500 may further comprise a back portion 504.

The island shaft 503, present in some embodiments, may provide at least two advantages. First, the island shaft 503 may enable a corresponding key to better fit within the recess 502. The island shaft 503 may help balance an inserted key within the recess 502 by providing an additional surface near the center of the recess on which the inserted key can be mated. Second, the island shaft 503 may increase the security of the locking plugs. While the recess 502 has a recess shape that provides security against unauthorized access, an island shaft 503 may prevent a counterfeit key from being inserted into the locking plug. If the counterfeit key does not have a corresponding island recess, then the counterfeit key may not be completely inserted, preventing the unauthorized person from transferring the necessary torsional force to the square key hole. In order to create a counterfeit key, a person would have to know not only the recess shape, but also the shape and size of the island shaft 503. The additional feature of the island shaft 503 may enhance the operation of the locking plug in addition to increasing the security of the locking plugs.

In particular embodiments, the recess shape is square. In other embodiments, the recess shape is hexagonal. In particular embodiments, the recess shape is a double square. Any suitable recess shape allowing for the engagement of the square key hole 102 would be appreciated by one having ordinary skill in the art upon viewing this disclosure.

FIG. 6 is a schematic drawing in front elevation of an example locking plug disposed within an example square key hole, according to a particular embodiment. The locking plug 500 may be disposed within the square key hole 102 by inserting the locking plug 500 within the square recess 105. When the locking plug 500 is disposed within the square key hole 102, a typical square key 400 is unable to be inserted into the square key hole 102. Since the square key hole 102 must be rotated to unlock the doors 101, preventing the insertion of a square key 400 prevents access into the railcar. Of course, access to the railcar is necessary for authorized persons in order to load and unload the cargo. The locking plug 500 comprising a front portion 501 defining a recess 502 having a recess shape provides the means to rotate the square key hole 102. A corresponding element inserted within the recess 502 may be rotated and transfer that torsional force to the square key hole 102 via the recess 502 and the locking plug 500 disposed within the square key hole 102.

The locking plug 500 may be disposed in an orientation such that the front portion 501 is facing the exterior of the doors 101 and railcar 100. Orienting the front portion 501 towards the exterior of the doors 101 and railcar 100 provides persons outside the railcar 100 access to insert an element into the recess 502. When the locking plug 500 is disposed within a square key hole 102, the square key hole 102 may still be engaged from inside the railcar. As such, the front portion 501 being accessible from the exterior, allows authorized persons the ability to insert an element into the recess 502 and engage the square key hole 102 and gain access to the railcar 100.

In particular embodiments, the size and shape of the locking plug 500 matches the size and shape of the square recess 105. In some embodiments the front portion of the locking plug 500 is the same size and shape as a cross-section of the square recess 105. Matching the size and shape of the square key hole 102 has several advantages. First, it maximizes the surface area shared between the square key hole 102 and the locking plug 500. Torsional force may be more easily transferred from the locking plug 500 to the square key hole 102 with a larger shared surface area because it lowers the pressure exerted on the square key hole 102 for an equal amount of force applied. Second, making the front portion 501 flush with the square recess 105 prevents material or debris from entering in between the locking plug 500 and the square key hole 102. Besides the enhanced wear and tear caused by entering water, ice, or debris, an unauthorized person may attempt to use any gaps to defeat the locking plug security measure by breaking, eroding, melting, or otherwise tampering with the device.

In particular embodiments, the locking plug 500 may be disposed within the square key hole 102 by connecting the back portion 504 to a portion of the square key hole 102. In order to prevent the unauthorized removal of the locking plug 500, an installer may connect the locking plug 500 to the square key hole 102 in a place which is inaccessible to a person outside the railcar. Since the back portion 504 should not be accessible from the exterior of the railcar 100 after the locking plug 500 is disposed within the square key hole 102, connecting to that portion is advantageous.

In particular embodiments, the back portion 504 is welded to the portion of the square key hole 102. Because railcars typically comprise of metals such as steel, welding may be the most readily available way of connecting the locking plug 500 to the square key hole 102. Additionally, since it may be desired to provide a locking plug 500 that is durable, it may also comprise a metal such as steel. Welding could provide a strong and lasting connection during the installation of the locking plug 500. One having ordinary skill in the art would appreciate that there may be a variety of ways to dispose the locking plug 500 within the square key hole 102 in view of this disclosure.

FIG. 7 is a schematic drawing in perspective view of example key element, according to a particular embodiment. The key element 700 may be provided to be inserted within the locking plug 500. The key element 700 may have a shaft 701 having a shape corresponding to the shape of the recess 502 of the locking plug 500.

In the particular embodiments illustrated, the key element 700 also includes a head portion 703. In the particular embodiment depicted, the head portion 703 may be hexagonal. In other embodiments, there may not be a separately defined head portion 703. In other embodiments, the head portion 703 may have another shape, for example a square. In some embodiments, the head portion 703 may be configured to be inserted into a separate tool or device as a bit, allowing for mechanized rotation of the key element 700.

As discussed in reference to FIG. 5, the locking plug 500 may prevent the square key hole 102 from being engaged by preventing the insertion of the conventional square key 400. Without a corresponding key element 700, a person would be prevented from providing a torsional force to engage the square key hole 102. Once inserted, the key element 700 may allow the necessary torsional force to be transferred through the key element 700 to the locking plug 500 and to the square key hole 102.

The key element 700 may only be provided to authorized individuals and the details of the locking plug recess shapes of the locking plugs may be limited to specific operators and vendors. Because the corresponding key element 700 is needed to engage the square key hole 102 with a locking plug 500, limiting possession of the key element 700 to authorized individuals would further prevent access to the interior of the railcar 100 from unauthorized persons.

In particular embodiments, the key element 700 may also have an island recess 702. The island recess 702 may be configured to match an island shaft 503 of a corresponding locking plug 500. As discussed in reference to FIG. 5, the addition of an island shaft 503 and corresponding island recess 702 may provide additional benefits such as increased security against counterfeiting and better operation.

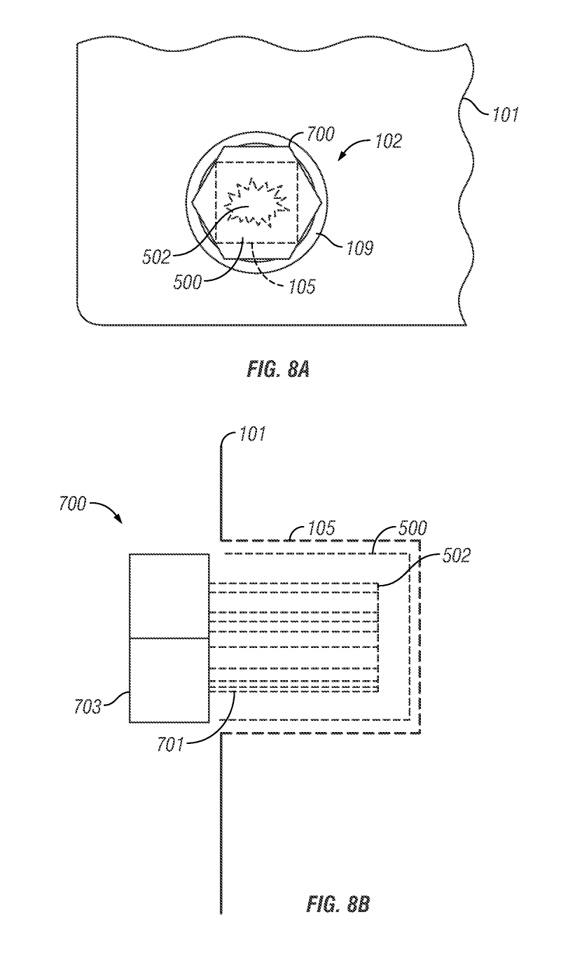

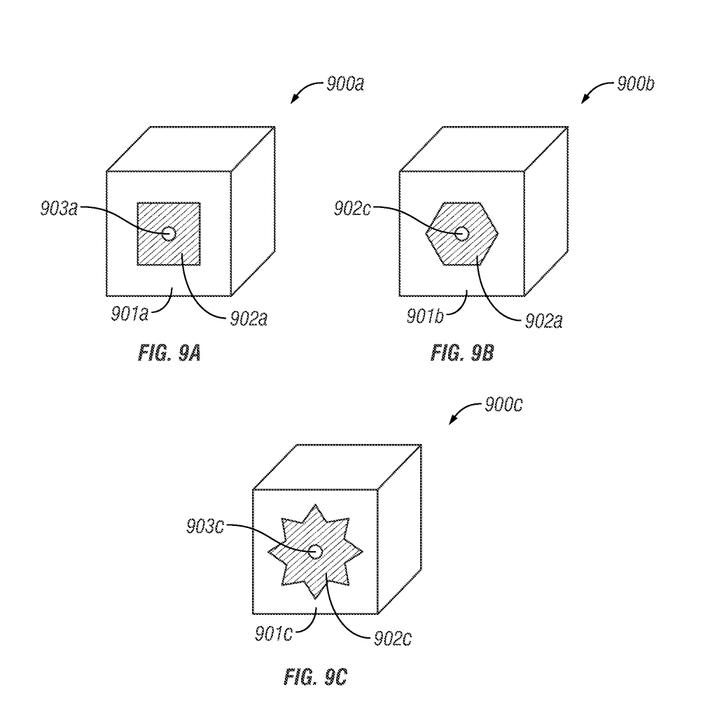

FIG. 8A is a schematic drawing in sectional elevation of an example key element inserted within an example locking plug disposed within an example square key hole, according to a particular embodiment. FIG. 8A depicts the key element 700 inserted in the locking plug 500 which is itself disposed within a square key hole 102 of the end doors 101. The shaft 701 may be inserted within the recess 502 of the locking plug 500. In particular embodiments, the head portion 703 remains outside the locking plug 500 when the key element 700 is inserted within the locking plug 500.

The head portion 703 may provide the authorized user a means to transfer a force into a torsional force applied to the locking plug 500 and thereby, the square key hole 102. For example, when an authorized user wants to access the interior of the railcar, the user may insert a corresponding key element 700 into the locking plug 500. As an example, after inserting a key element having a hexagonal head portion 703, the user may then use a conventional wrench or another tool which fits over a hexagonal element to apply a force to the key element 700. The user may then continue to apply force to the key element 700, which, if disposed in the locking plug 500, will operate to engage the square key hole 102 to provide access to the interior of the railcar.

FIG. 8B is a cross-section side view of FIG. 8A. FIG. 8B depicts a side view of the key element 700 inserted within locking plug 500 disposed within the end door 101. The key element 700, when inserted, may place the shaft 701 inside the recess 502. In particular embodiments, the entire shaft 701 is inserted within the recess 502. In particular embodiments, the entire recess 502 is filled when the shaft 701 is inserted.

In particular embodiments, the exterior of the shaft 701 is flush with the interior of the recess 502 such that torsional force applied to the key element 700 would cause a torsional force to be applied to the locking plug 500. Maximizing the space filled by the shaft 701 in the recess 502 maximizes the surface area shared between the key element 700 and the walls of the recess 502 of the locking plug 500. Torsional force may be more easily transferred from the key element 700 to the locking plug 500 (via the walls of the recess 502) with a larger shared surface area because it lowers the pressure exerted on the square key hole for an equal amount of force applied.

The key element 700 may operate to transfer a torsional force to the locking plug 500 via the portion of the locking plug 500 defining the recess 502. A torsional force applied to the locking plug 500 may operate to engage the square key hole 102 as described above in relation to FIGS. 2A and 2B.

In particular embodiments, not depicted in FIGS. 8A and 8B, where the locking plug 500 has an island shaft 503, the key element 700 may have an island recess 702. In those embodiments, when the key element 700 is inserted in to the locking plug 500, the island shaft 503 may fit within the island recess 702. As discussed above, the inclusion of an island shaft 503 and island recess 702 may improve the operation of the key element 700 and locking plug 500 pair.

FIGS. 9A-C are schematic drawings in perspective view of example locking plugs, according to various particular embodiments. FIG. 9A depicts an example locking plug 900a. The locking plug 900a may have a front portion 901a and a recess 902a with a square recess shape. In particular embodiments, the locking plug 900a may have an island shaft 903a. In such embodiment, there would be a key element with a shaft shape corresponding to the square recess shape.

FIG. 9B depicts an example locking plug 900b. The locking plug 900b may have a front portion 901b and a recess 902b with a hexagonal recess shape. In particular embodiments, the locking plug 900b may have an island shaft 903b. In such embodiment, there would be a key element with a shaft shape corresponding to hexagonal recess shape.

FIG. 9C depicts an example locking plug 900c. The locking plug 900c may have a front portion 901a and a recess 902c with a double square recess shape. In particular embodiments, the locking plug 900c may have an island shaft 903c. In such embodiment, there would be a key element with a shaft shape corresponding to the double square recess shape.

The examples described above in regards to FIGS. 9A-C are merely illustrative examples of particular embodiments of the invention disclosed here within. Any suitable locking plug recess shape allowing for the engagement of the square key hole 102 of a railcar door would be appreciated by one having ordinary skill in the art upon viewing this disclosure.

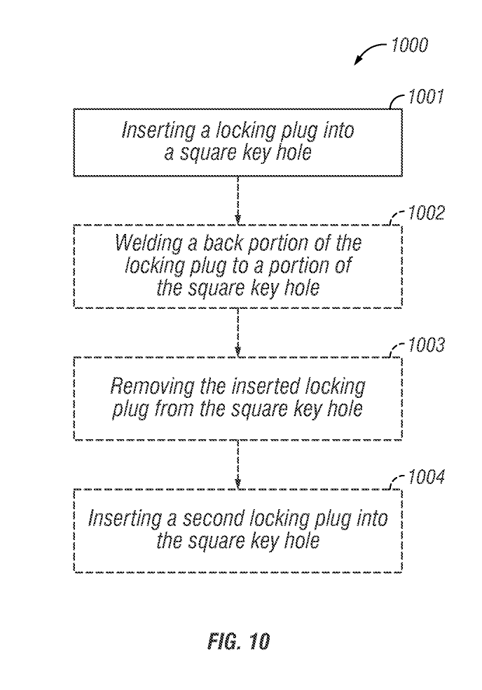

FIG. 10 is a flow diagram illustrating an example method of securing rail car doors, according to some embodiments. FIG. 10 describes a method 1000 for securing railcar doors. The method 1000 may include a first step 1001 of inserting a locking plug into a square key hole of a railcar door. In some embodiments, the railcar door is an end door of an auto rack. The insertion of the locking plug into to the square key hole may provide additional security to the cargo on the railcar as described above in reference to FIGS. 1 through 9.

In particular embodiments, the method may include a second step 1002 of welding a back portion of the locking plug to a portion of the square key hole. Welding provides certain advantages as described above, including durability and the ability to periodically change the locking plug.

In particular embodiments, the method 1000 may comprise a step 1003 of removing an already inserted locking plug 500 from the square key hole 102 and a step 1004 of placing a second locking plug into the square key hole 102. Removing an existing locking plug and placing a different locking plug may provide several advantages. For example, a locking plug may be subject to normal wear and tear and may be in a state where it is no longer operational. On the other hand, intentional tampering may render the locking plug unsuitable for use. Additionally, the compromise of the corresponding key element, or locking plug designs, may prompt the replacement of corresponding locking plugs. In some embodiments, step 1004 may include a welding the a back portion of the second locking plug to a portion of the square key hole after the first locking plug is removed.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components.

Although embodiments of the present disclosure and their advantages have been described in detail, it should be understood that various changes, substitutions and alternations can be made herein without departing from the spirit and scope of the invention as defined by the claims below.

The example embodiments described herein may be included with a new railcar or new railcar doors. In some embodiments, the components described herein may be retrofitted to existing railcars or railcar doors.

Some embodiments of the present disclosure may provide numerous technical advantages. For example, particular embodiments may provide additional security preventing access to railcars beyond the addition of more bolt seals or other locks, such as pad locks. The locking plugs may prevent the engagement of the square key hole without the corresponding key element thereby preventing the rotation of the square key hole and allowing the railcar doors to be opened.

In particular embodiments, the locking plugs may be inserted into an existing square key hole and secured by a weld. The weld would prevent easy removal of the locking plugs, but would also allow for periodic replacement of the locking plug. The key elements corresponding to particular locking plugs may be serialized, allowing lost or stolen keys to be traced to particular operators or vendors, providing an additional layer of deterrence.

Additionally, a variety of recess shapes may be produced, increasing the difficulty of acquiring the corresponding key element in order to gain unauthorized access to the railcar. The locking plug may define a recess with a regular polygonal shape, such as a square or a hexagon.

The key element may include a head portion with a commonly used shape for transmitting torsional force, allowing for compatibility with commonly used tools and ease of use. The locking plug and key element combination may include an island shaft and island recess pair which work together to ensure a better fit between the locking plug and key element in operation.

Some embodiments may benefit from some, none, or all of these advantages. Other technical advantages may be readily ascertained by one of ordinary skill in the art.

1. An apparatus for railcar doors, comprising:
a locking plug configured to be disposed within a square key hole, the locking plug comprising a front portion defining a recess having a recess shape; and
a key element comprising a key element shaft having a shape corresponding to the recess shape, the key element configured to be inserted into the locking plug and to transfer a torsional force from the key element to the square key hole.

2. The apparatus of claim 1, wherein:
the locking plug further comprises a back portion; and
the locking plug is disposed within the square key hole by a weld connecting the back portion of the locking plug to a portion of the square key hole.

3. The apparatus of claim 1, wherein the key element further comprises a hexagonal head portion.

4. The apparatus of claim 1, wherein:
the locking plug further comprises an island shaft within the recess; and
the key element shaft defines a corresponding island recess.

5. The apparatus of claim 1, wherein the recess shape is square.

6. The apparatus of claim 1, wherein the recess shape is hexagonal.

7. The apparatus of claim 1, wherein the apparatus is coupled to a locking mechanism of at least one railcar door, the locking mechanism configured to be activated when the key element is inserted into the locking plug and torsional force is applied by the key element.

8. A method for securing railcar doors, comprising:
inserting a locking plug into a square key hole, the locking plug comprising a front portion defining a recess having a recess shape; and
wherein a key element comprising a key element shaft has a shape corresponding to the recess shape, the key element configured to be inserted into the locking plug and to transfer a torsional force from the key element to the square key hole.

9. The method of claim 8, wherein:
the locking plug further comprises a back portion; and
inserting the locking plug into the square key hole includes welding the back portion of the locking plug to a portion of the square key hole.

10. The method of claim 8, wherein the key element further comprises a hexagonal head portion.

11. The method of claim 8, wherein:
the locking plug further comprises an island shaft within the recess; and
the key element shaft defines a corresponding island recess.

12. The method of claim 8, wherein the recess shape is a square.

13. The method of claim 8, wherein the recess shape is a hexagon.

14. The method of claim 8, wherein inserting the locking plug couples the locking plug to a locking mechanism of at least one railcar door, the locking mechanism configured to be activated when the key element is inserted into the locking plug and torsional force is applied by the key element.

15. An apparatus, comprising:
at least one railcar door, the at least one railcar door comprising a locking mechanism, the locking mechanism defining a square key hole, the locking mechanism connected to at least one locking pin;
a locking plug configured to be disposed within the square key hole, the locking plug comprising a front portion defining a recess having a recess shape; and
a key element comprising a key element shaft having a shape corresponding to the recess shape, the key element configured to be inserted into the locking plug and to transfer a torsional force from the key element to the square key hole, wherein the torsional force operates to turn the square key hole activating the at least one locking pin to allow the at least one rail car door to be opened.

16. The apparatus of claim 15, wherein:
the locking plug further comprises a back portion; and
the locking plug is disposed within the square key hole by a weld connecting the back portion of the locking plug to a portion of the square key hole.

17. The apparatus of claim 15, wherein the key element further comprises a hexagonal head portion.

18. The apparatus of claim 15, wherein:
the locking plug further comprises an island shaft within the recess; and
the key element shaft defines a corresponding island recess.

19. The apparatus of claim 15, wherein the recess shape is a square.

20. The apparatus of claim 15, wherein the recess shape is a hexagon.
